(19) United States
(12) Patent Application Publication
(10) Pub. No.: US 2026/0111662 A1
(43) Pub. Date: Apr. 23, 2026

(54) AUTOMATICALLY MAPPING SENTENCES TO EDUCATIONAL STANDARDS USING INTEGRATED PROGRAMMATIC AND SPECIALIZED GUIDED AND CONSTRAINED ARTIFICIAL INTELLIGENCE

(71) Applicant: 2hr Learning, Inc., Austin, TX (US)

(72) Inventors: Joshua Singer, Austin, TX (US); Cameron Kelley, Franklin, TN (US)

(73) Assignee: 2hr Learning, Inc., Austin, TX (US)

(21) Appl. No.: 19/367,655

(22) Filed: Oct. 23, 2025

Related U.S. Application Data
(60) Provisional application No. 63/711,129, filed on Oct. 23, 2024.

(51) Int. Cl. G06F 40/20; G06F 16/3329; G06Q 50/20

(52) U.S. Cl. CPC G06F 40/20; G06F 16/33295; G06Q 50/20

(57) ABSTRACT

An automatic sentence mapping system analyzes one or more input sentences to identify one or more associated education language standards such as Common Core English Language Arts (CCELA). One of the main components of the automatic sentence mapping system is mapping functions library. The mapping functions library includes information regarding various educational language standards. For each educational language standard, a set of functions within the standards are defined for validating the input sentences against a specific standard. Most functions defined within an educational language standard are designed for grammatical checks within a sentence against the associated educational language standard while some functions are designed for complex linguistic analysis that leverage artificial intelligence, such as large language models, for performing checks on the sentence for the desired associate language standard.

### CROSS-REFERENCE TO RELATED APPLICATION(S)

This application claims the benefit under 35 U.S.C. § 119 (e) and 37 C.F.R. § 1.78 of U.S. Provisional Application No. 63/711,129, which is incorporated by reference in its entirety.

### FIELD OF THE INVENTION

The present invention relates in general to the field of electronics and more specifically to a system for automatically mapping sentences to educational standards using modular functions, Natural Language Processing (NLP) libraries, and Large Language Models (LLMs).

### BACKGROUND OF THE INVENTION

The Common Core State Standards (CCSS) are a set of educational standards designed to ensure that students receive a uniform education across various locations where these standards are implemented. The CCSS outlines what students from Grades K-12 should learn at various grade levels. These standards encourage the integration of literacy skills across different subject areas.

The CCSS outlines clear and specific curriculum standards to be followed at each grade level. These standards help teachers understand what content is appropriate for each grade level and how to structure lessons for effective teaching. These standards support teachers in planning lessons that progressively build on students' skills. Further, these standards help students focus on developing critical thinking, analytical skills, and the ability to communicate effectively, which are crucial for college and career readiness.

Teachers generally use the CCSS in lesson planning. Teachers create their lesson plans, assignments, and assessments either on paper or using digital resources. Digital platforms help reduce teachers' workload and ensure consistency in teaching materials. However, there is a need to improve existing tools and systems to check if educational content aligns with the correct educational standards.

### BRIEF DESCRIPTION OF THE DRAWINGS

The systems and methods described herein may be better understood, and their numerous objects, features, and advantages are made apparent to those skilled in the art by referencing exemplary embodiments depicted in the accompanying figures. The use of the same reference number throughout the several figures designates a like or similar element.

FIG. 1 depicts an exemplary automatic sentence mapping system that maps sentences with educational standards using modular functions, an NLP library, and LLMs.

FIG. 2 depicts an exemplary automatic sentence mapping process using the automatic sentence mapping system of FIG. 1.

FIG. 3 depicts an exemplary sentence mapping workflow along with key components used by the exemplary sentence mapping system of FIG. 1.

FIG. 4 depicts an exemplary network environment in which the system of FIG. 1 and the process of FIG. 2 may be practiced.

FIG. 5 depicts an exemplary computer system.

### DETAILED DESCRIPTION

An automatic sentence mapping system analyzes one or more input sentences to identify one or more associated education language standards such as Common Core English Language Arts (CCELA). One of the main components of the automatic sentence mapping system is the mapping functions library. The mapping functions library includes information related to various educational language standards including but not limited to CCELA. For each educational language standard, a set of functions within the standard are defined for validating the input sentences against the specific standard. Most functions defined within the educational language standard are designed for grammatical checks to be run on the sentence against the associated educational language standard, whereas some functions are designed for complex linguistic analysis that leverage one or more artificial intellgence engines, such as large language models, for performing checks on the sentence for the desired associate language standard. In addition, a few functions may use natural language libraries for function execution and mapping of standards against the sentences.

An input sentence from the sentence database is transferred to the sentence mapping system. The sentence mapping system interacts with the mapping functions library in order to process the input sentence. In particular, the sentence mapping system receives functions pertaining to various educational language standards from the mapping functions library. Once received, the sentence mapping system executes one or more functions included in each standard to check the association of input sentence with the one or more language standards. The sentence mapping system analyze the input sentence through the use of modular functions, Natural Language Techniques (NLPs) library or Large Language Model (LLM).

The sentence mapping system further generates prompt instructions for generating positive and negative test sentences for each educational language standard. These positive and negative sentences are used as review sentences to validate that the input sentence is associated with the underlined language standard. For example, if an input sentences is mapped against an English language arts standard L.3.1.c based on execution of a modular function, the sentences mapping system runs a check to see if the input sentence maps to the positive sentence too. If the input sentence maps to the positive sentence, the input sentence passes the function to tag against the given language standard. However, if the input sentence maps against the negative sentence, the sentence mapping system discards the input sentence such that the input sentence is rejected to be mapped against the given standard. Therefore, the disclosed sentence mapping system enables mapping of sentences against one or more relevant language standards. Based on this mapping, these sentences can be used in generation of standard-specific content for various grade levels. Other advantages of the sentence mapping system may include evaluation of students to check their level of mastery against one or more language standards, as the content used by the students for learning is already mapped against associated one or more language standards.

The system and method set forth herein address technical issues with generating the desired outputs described herein. Conventionally, manual processes were used to generate the desired outputs and were very tedious and time consuming. The present system and method utilize an automated system that does not merely automate a manual process or use a conventional system in a conventional way. The present system and method utilize one or more artificial intelligence (AI) engines and integrate programmatic process management to technologically guide and constrain the one or more AI engines to produce the desired outputs in a completely different way than any manual process and different than normal use of programs and AI engines. Utilizing specially engineered guidance and control to direct an AI system to solve the problems below presents a technical problem that requires a technical solution. The system and method described below are not simply engaging a computer to carry out conventional mental processes, but rather change how computers (and AI systems, specifically) operate to achieve the generation results that were not previously possible or were substantially inefficient prior to the system and method set forth below. The AI system needs specific technical guidance, control, and constraints to achieve results that are not otherwise achievable.

Prompts are used to guide and constrain each AI engine. The prompts guide each AI engine by steering the AI engine(s). “Guiding” an AI engine refers to providing the AI engine with a general direction or framework to shape the AI engine's behavior or decision-making process. Guiding sets goals or principles. Guiding allows the AI engine some flexibility to interpret and adapt, much like giving it a compass to navigate rather than a fixed path.

Constraining each AI engine includes imposing specific, hard limits or rules on what each AI engine can do. Constraining an AI engine can also include providing specific input data to not only guide but also constrain the scope of each AI engine's reasoning basis and response. Constraining each AI engine assists with aligning the AI engine(s) for its (their) intended use.

Normally AI engines are provided a single user prompt requesting the AI engine, such as OpenAI's ChatGPT and its various implementations such as Anthropic's Claude Sonnet, to perform a task and produce an output. However, this conventional AI engine prompting method has a variety of technical shortcomings. Without proper guidance and constraints, an AI engine will not produce the desired output specified as produced by the system and method described herein. Instead, the AI engine will produce many unusable outputs that are unusable for a variety of reasons including so-called “hallucinations” where the AI engine presents fabricated information, duplicate outputs, too few outputs, too many outputs, outputs that do not meet desired criteria, and so on. Without special technical guidance, the AI engine cannot reliably be applied to generate desired outcomes.

The system and method generate decomposed, technically engineered AI prompts to include selected and integral AI engine guidance and constraints. Conventional approaches often do not recognize the technical capabilities of an engineered prompt to guide and constrain an AI engine to generate a desired output. The technically engineered prompts are generated and guided with programmatic, automatic inputs specifically designed to unconventionally guide and constrain an AI engine to produce desired outputs, perform quality control to retain or automatically discard outputs that do not meet guidance and constraints, and make the desired outputs available for use, such as use by computer system applications. In at least one embodiment, the problem to be solved by the integrated programmatic and AI engine system and method is uniquely and unconventionally decomposed, and AI prompts are used to solve the decomposed problem. Furthermore, the programmatic inputs to the decomposed AI prompts provide guidance to meet desired output characteristics.

Determining a number of prompts, the guidance and constraints within each prompt, and data flowing from one AI engine prompt to another, in addition to testing a number of prompts for the decomposed problem, testing within each prompt, and validating a desired quality of outputs becomes an intractable combinatorial problem without technical guidance and constraint of the system and method described herein. Thus, the present system and method described implement an integration of programmatic management over decomposed prompts with engineered AI engine guidance and constraints to effect an improvement in AI, programmatic AI management, and AI integrated with programmatic management technology. The present system and method allow computer systems to include programmatic management, one or more AI engines, and one or more data sources to produce the output described herein that previously could not be produced with conventionally prompted AI engines or could only be produced by humans utilizing a completely different, time consuming, and tedious process. The system and method improve conventional methods through the use of a programmatic AI engine management system to generate decomposed, technically engineered AI prompts to include selected and integral AI engine guidance and constraints. It is, for example, the incorporation of the programmatic AI engine management system to generate decomposed, technically engineered AI prompts to include generated, integral, and unconventional AI engine guidance and constraints and execution by the one or more AI engines to provide useful results that improve existing technical processes, which is not an automation of a conventional process.

Programmatic components and AI engines generally utilize one or more processors that have access to memory, which may include one or more storage components, to execute and perform functions. An AI engine is a core hardware and software system that enables artificial intelligence applications to process data, learn patterns, and generate insights or actions. It functions as the brain behind AI-driven systems, facilitating tasks such as machine learning, natural language processing, and decision-making. Exemplary components of an AI engine are:
1. Machine Learning Models—Algorithms that analyze data, recognize patterns, and make predictions.
2. Neural Networks—Deep learning architectures that mimic the human brain for tasks like image and speech recognition.
3. Data Processing Module—Handles raw data input, transformation, and feature extraction.
4. Inference Engine—Applies trained models to make real-time decisions based on new data.
5. Optimization Algorithms—Improves model efficiency, reducing errors and improving predictions.
6. Natural Language Processing (NLP) Module—Enables AI engines to understand, interpret, and generate human language (e.g., chatbots, voice assistants).
7. Computer Vision Module—Allows AI to interpret and analyze images or videos.
8. Reinforcement Learning Mechanism—Helps AI learn from trial and error, optimizing performance over time.
9. API Interface—Connects the AI engine with applications, enabling integration with other software or platforms.

Examples of AI Engines include: XAI's Grok and variations thereof, Google TensorFlow, Meta's PyTorch, Microsoft Azure AI, OpenAI's ChatGPT and variations thereof, IBM Watson, OpenAI Whisper, Google BERT & T5, Amazon Lex, Anthropic Claude, DeepMind's AlphaCode, Google Vision AI, Meta's DINO & SAM (Segment Anything Model), NVIDIA DeepStream. OpenCV AI Kit, Amazon Polly. Google WaveNet, Deepgram.

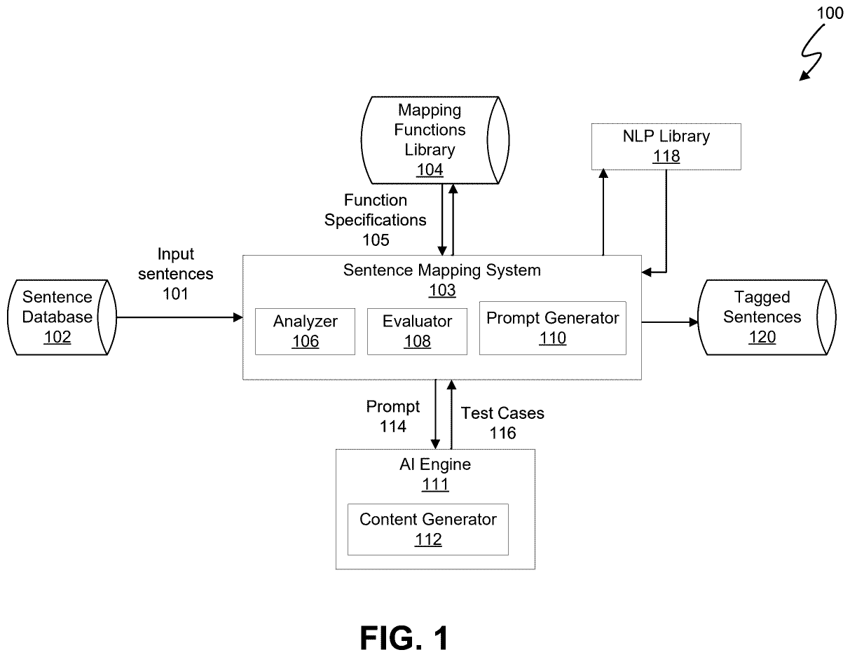

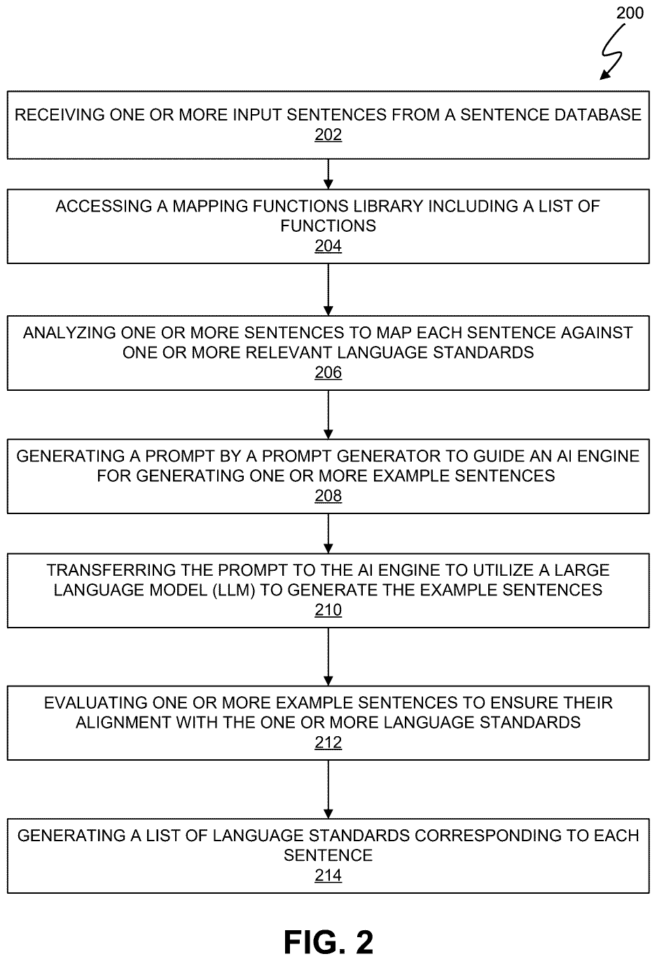

FIG. 1 depicts an automatic sentence mapping system 100, designed to map instructional content in the form of one or more input sentences 101 aligned with educational language standards. FIG. 2 depicts an automatic sentence mapping process 200 utilized by the automatic sentence mapping system 100.

The automatic sentence mapping system 100 includes a sentence database 102 which provides input to a sentence mapping system 103 in the form of one or more sentences. Before the input sentences 101 from the sentence database 102 are allowed to interact with the sentence mapping system 103, the sentence mapping system 103 interacts with a mapping functions library 104. The mapping functions library 104 includes the definitions and descriptions of various educational language standards, along with the function specifications for each educational language standard. The function specifications include a list of functions included under each educational language standard, where the functions under each educational language standard are to be executed for validating mapping of the sentence against the given educational language standard. The function specification includes additional metadata or requirements for execution. “Memory” can be a single memory component or a collection of multiple memory components. Some educational language standards include functions that require interaction with Large Language Models (LLMs) for complex linguistic analysis, thereby confirming mapping of input sentences 101 with given educational language standards.

One of the components of the sentence mapping system 103 is analyzer 106. The analyzer 106 receives input sentences 101 from the sentence database 102. Subsequently, the analyzer receives details related to one or more educational language standards from the mapping functions library 104, which allows the analyzer 106 to analyze if the input sentences 101 maps against the one or more standards. To that end, the analyzer 106 receives set of functions included within each language standard, where all the included functions are to be executed by the analyzer 106 to check if the input sentences maps against a picked language standard. The analyzer 106 then maps the functions within the different educational language standards to their actual methods and execute the functions. For example, the analyzer 106 may analyze an input sentence 101 by interacting with a Natural Language Processing (NLP) Library 118 such as SpaCy library or any suitable NLP library. Further, the analyzer 106 may interact with an LLM model such as OpenAI's GPT model for executing functions requiring complex linguistic analysis. After processing each input sentences 101, the analyzer 106 determines a list of specific language standards against which the input sentence 101 maps.

The sentence mapping system 103 further includes an evaluator 108. The evaluator 108 first accesses the function specifications for all the education language standards by loading the mapping functions library 104. Subsequently, the evaluator 108 interacts with a prompt generator 110 for creating a prompt 114 including specific instructions for generating positive and negative sentences 116 (may also be referred as ‘positive and negative test cases 116’ or ‘test cases 116’) for each education language standard. The specific instructions include sufficient details to guide an AI engine 111 for generation of positive and negative test cases 116. The prompt 114 may include a system prompt defining set of boundary conditions for the AI engine 111, guiding its behavior to act as a helpful grammar and educational assistant. The prompt 114 additionally includes a user prompt including the script and format for generation of positive and negative test cases 116. The prompt generator 110 combines the system prompt and user prompt, and passes the final prompt 114 to the AI engine 111 for generation of test cases 116. The AI engine 111 generates one or more sentences including positive and negative test cases 116 for each education language standard.

The evaluator 108 then interacts with the analyzer 106 to test the generated test cases 116. The evaluator 108 transfers the generated test cases 116 to the analyzer 106, which processes the generated test cases 116 in the same manner as it processes the input sentences 101. The analyzer 106 then validates each generated sentence with predefined education language standards against the education language standards that it maps to after being processed by the analyzer 106. If the educational language standards mapped to a generated sentence are identical to its predefined educational language standards, then the accuracy rate is recorded by the evaluator 108. The generated sentences that are validated by the analyzer 106 are then gathered by the evaluator 108. The evaluator 108 then stores the generated sentences validated by the analyzer 106 for each language standard in the memory functions library 104 and discards the generated sentences not validated by the analyzer 106. The analyzer 106 then transfers the processed input sentences 101 tagged to one or more educational language standards to a database of tagged sentences 120.

Referring to FIGS. 1 and 2, in operation 202, receiving one or more input sentences 101 from a sentence database 102. A user initializes a sentence database 102 containing a list of sentences in the English language. The list of sentences included in the sentence database 102 are aligned to one or more educational language standards that are included in the Common Core English Language Arts (CCELA) Standard. The Common Core English Language Arts (CCELA) standards are a set of educational guidelines that outline the reading, writing, speaking, listening, and language skills students should master at each grade level (K-12). The CCELA standards emphasize critical thinking, evidence-based writing, and comprehension of complex texts to prepare students for college and careers. The list of sentences is transferred as input to a sentence mapping system 103, where the sentence mapping system 103 tags the input sentences 101 to the respective language standards deemed relevant for individual sentences.

In operation 204, accessing a mapping functions library 104 including a list of functions. The sentence mapping system 103 accesses a mapping functions library 104, which contains information regarding a list of education language standards. Each language standard contains function specifications 105 including list of functions that are to be used as checking function to check if an input sentence maps against the given language standard. The sentence mapping system 103 executes the checking functions to map the input sentence 101 against the specific education standard. The functions associated with an education language standard in mapping functions library 104 define the specific grammatical checks required to determine how the input sentence 101 aligns or maps with the relevant educational language standard. The mapping functions library 104 is an exemplary Java Script Object Notation (JSON) file, which is a lightweight and easy-to-read text file used to store and exchange data. The JSON file organizes information in a structured way using key-value pairs, similar to how dictionaries or address books work. The JSON format is machine readable and allows for efficient searching and retrieval. An instance of the information pertaining to the education language standards and the corresponding checking functions is represented as the below JSON object:

```
{
  “standard_id”: “L.3.1.c”,
  “description”: “Use abstract nouns (e.g., childhood)”,
  “functions_to_satisfy”: “all”,
  “functions”: [
    {
      “function_type”: “check_words_exist”,
      “metadata”: {
        “list_of_words”: [“childhood”, “justice”, “love”, “bravery”, ...]
      }
    }
  ],
“positive_cases”: [
“My childhood was filled with sunny days and laughter.”,
  “Bravery is not the absence of fear, but the strength to confront it.”
  ],
  “negative_cases”: [
    “The orange cat lazily prowled through the garden.”,
    “This morning, I ate a hearty breakfast.”
  ]
}
```

The overall structure is wrapped in curly braces { } to denote it as a JSON object, and each key-value pair is separated by a comma. The given structure represents an example entry for an educational language standard in the mapping functions library 104. In the given structure, the JSON object stores simple key-value pairs, “standard_id”: “L.3.1.c”, “description”: “Use abstract nouns (e.g., childhood)” and “functions_to_satisfy”: “all” where “standard_id”, “description”, and “functions_to_satisfy” are keys and “L.3.1.c”, “Use abstract nouns (e.g., childhood)” and “all” are corresponding pairs. Additionally, another key, “functions”, holds an array as its value.

An array is defined as a collection of items that are all the same type, stored together in a specific order. For the given example, inside the array, there is a nested object with two key-value pairs. The first key “function_type” has a value “check_words_exist”. The second key “metadata” holds a second nested object. Within the second nested object, the key “list_of_words” maps to an array containing multiple string elements: “childhood”, “justice”, “love”, “bravery”, and so on. Finally, there are two keys: “positive_cases” and “negative_cases”, each holding arrays of strings. The key “positive_cases” maps to an array containing two text strings: “My childhood was filled with sunny days and laughter.” and “Bravery is not the absence of fear, but the strength to confront it.”. Similarly, the key “negative_cases” maps to another array with two text elements: “The orange cat lazily prowled through the garden.” and “This morning, I ate a hearty breakfast.”. Each array can store multiple entries, making it useful for handling collections of similar information.

The key-value pairs, “standard_id”: “L.3.1.c” and “description”: “Use abstract nouns (e.g., childhood)” in the above defined JSON object define the shorthand notation for the specific education standard and the description of the corresponding standard in sentence form. The key-value pair “functions_to_satisfy”: “all” indicates that for a sentence to be mapped under the given education language standard, it needs to fulfil all the checking functions listed under the “functions” key. In some standards, the value for the key “functions_to_satisfy” may be listed as “any” which indicates that for a sentence to be mapped under the given standard, the sentence needs to fulfill at least one of the checking functions listed within the “functions” key. As described earlier, within the key, “functions” that hold an array as its value, there are additionally two key-value pairs. The first key “function_type” specifies the action to be performed on the sentence based on listed specifications which in the example case are defined under the second key, “metadata” which takes in another nested object. Within the nested object held by the “metadata” key, another key, “list_of_words” again maps to an array containing multiple words or vocabulary associated with the specified standard. The key “metadata” generally takes in as an array, additional criteria associated with the key “function_type” which may include but is not limited to the additional grammatical specification such as “list_of_words” as shown in the above example, parameters such as “model_name”, “system_prompt”, “user_prompt”, if the key, “function_type” for an associated function within a specified education standard interacts an AI engine, such as a Large Language Model (LLM), for running more complex checks to map a sentence to the specified educational standard.

A Large Language Model (LLM) is an exemplary type of AI engine machine learning model designed to process and generate human-like text by understanding patterns and relationships in large volumes of text data. Reference below refer to an LLM, but other AI engine models can be used. Examples of LLMs include GPT (Generative Pre-trained Transformer) and BERT (Bidirectional Encoder Representations from Transformers). Once trained, an LLM can perform various language tasks such as text generation, translation, summarization, sentiment analysis, and question-answering, often without needing task-specific fine-tuning. The parameter “model_name” specifies the name of the AI engine to be used, such as GPT-4. A “system_prompt” defines the boundary conditions, the behavior, tone, or style the AI engine should adopt. It provides background instructions on how the LLM should respond to queries, such as being technical, formal, or humorous. In contrast, a “user_prompt” represents the input or question provided by the user to the LLM. It indicates what information or action the user needs, such as asking a question, issuing a command, or seeking clarification. The LLM generates a response based directly on the user prompt.

Additionally, the key “positive_cases” provides example sentences whose grammatical structure and vocabulary meet the specified standard. In contrast, the key “negative_cases” provides the example sentences in which the grammatical structure and vocabulary do not align with the specified standard. The keys: “positive_cases” and “negative_cases” are written into the JSON file through the evaluator 108, which will be described later in the description. The mapping function library 104 therefore entails the definition of the specific education standards along with description of the standard against which the input sentences 101 are to be mapped. The mapping function further specifies the function code used to validate if the input sentences 101 is aligned with the specified education standard or not.

In operation, 206, analyzing one or more sentences to map each sentence against one or more relevant language standards. The input from the sentence database 102, including one or more sentences, is transferred to an analyzer 106 within the sentence mapping system 103. The analyzer 106 processes the input sentences 101 and then implement the checks based on the function specification mentioned for each education language standard. The analyzer 106 manifests as a set of programming language codes written in Python Language. Python is a popular, high-level programming language known for being easy to read and write. It uses simple syntax that resembles a lot like plain English. Additionally, Python is a versatile programming language which can be used for tasks like building websites, automating repetitive processes, analyzing data, creating artificial intelligence (AI) models, or developing software applications.

The analyzer 106 performs its role of processing the input sentences 101 through interaction with various software modules. Modules are files containing Python code that can be imported or reused across other programs. There are modules which are built into the Python library while others are third party tools which are not included within the standard Python library. The third party tools extend the functionality of Python by providing specialized functions for various tasks like, web development, Natural Language Processing (NLP) and for interacting with Large Language Models (LLM) for generating meaningful responses for text based prompts. The analyzer 106 uses built-in modules such as those for interacting with JSON format files and for interacting with the underlying operating system which include but are not limited to Windows, Linux and macOS. The interaction of the analyzer 106 with the JSON files includes tasks such as reading, writing, and parsing JSON data, as well as converting data between Python objects such as dictionaries and JSON strings. The interaction of the analyzer 106 with the operating system includes tasks including but are not limited to path handling, accessing and changing environment variables. Path handling includes working with file paths and modifying them regardless of the operating system that is being used. Environment variables are operating system settings that store information about the operating system environment. Python uses environment variables through the built-in operating system module, which provides functions to retrieve the value of a specific environment variable.

The analyzer 106 additionally interacts with the two third-party tools for processing the input from the sentence database 102. These tools are: AI engine 111 and an NLP library 118. An AI engine 111 is a software framework or system that utilizes artificial intelligence (AI) techniques to perform tasks that typically require human intelligence. These tasks can include problem-solving, decision-making, learning from data, and understanding natural language. AI engines leverage algorithms, machine learning models, and sometimes deep learning to analyze data, recognize patterns, and generate insights or predictions. A standard AI engine 111 may integrate one or more large language models (LLMs) to enhance its capabilities in understanding and generating human-like text. The AI engine 111 in particular uses the Open AI's GPT LLM model for complex analysis. A Natural Language Processing (NLP) library 118 refers to a collection of built-in tools and functions designed for analyzing and manipulating human language data. An example of a powerful NLP Library 118 utilized by Python language is SpaCy. SpaCy provides features such as tokenization, part-of-speech tagging, named entity recognition, making it suitable for tasks ranging from basic text analysis to complex machine learning applications. Additionally SpaCy is built for performance and scalability, enabling the handling of large volumes of text quickly and for seamless integration with other machine learning frameworks. There are other NLP libraries available in Python such as Natural Language Toolkit (NLTK). Though SpaCy and NLTK are powerful libraries used in Python, the use of NLP libraries is not limited to Python programming language only. There are NLP libraries used in other programming languages as well.

The analyzer 106 accesses the mapping functions library 104 and interacts with the NLP library 118 to process the input sentences 101 through tokenization and part of speech tagging. Tokenization refers to the process of splitting a text into smaller units called tokens. These tokens can be words, phrases, or symbols. The main purpose of tokenization is to break down a large piece of text into manageable chunks for further analysis and processing. Part of speech (POS) tagging refers to the process of assigning a part of speech to a token in a text. A part of speech mainly includes categories such as nouns, verbs, adjectives, adverbs, prepositions, and conjunctions. POS tagging is essential for understanding the grammatical structure of a sentence and is one of the main functions of Natural Language Processing (NLP). The analyzer 106 then executes the functions listed for the various educational language standards by mapping the “function types” for various educational language standards listed in the mapping functions library 104 to their actual methods. The identifier “function_types” listed for each educational language standard is essentially the name of the function. The methods for each “function type” describe how the objective associated with the “function type” is implemented.

The analyzer 106 further includes methods for functions listed in the educational standard document which require interaction with the AI engine 111 for performing complex analysis for specific standards. To perform complex analysis on the input sentences 101 for specific educational language standards, the analyzer 106 interacts with the AI engine 111 and leverages one or more of its constituent large language models (LLMs) through the predefined system and user prompts listed in the JSON file within the mapping functions library 104. Complex analysis includes grammatical checks that may require more nuanced reasoning and are often too intricate to be generated manually. After processing the input sentences 101, the analyzer 106 evaluates the input sentences through a criteria listed by the key: “functions_to_satisfy” within the JSON file in the mapping functions library 104 for each educational language standard. A sentence is determined to pass a standard if it fulfills a required criteria. For a specific educational language standard, functions with the value “all” corresponding to key: “functions_to_satisfy”, must return the parameter “True”. This confirms that the input sentence fulfills the criteria for all the functions listed within a specified education language standard. Similarly, the functions with value “any” corresponding to the key: “functions_to_satisfy”, must also return the parameter “True”. This confirms that the input sentences 101 fulfills the criteria for at least one of the functions listed within a specified education language standard. The analyzer 106 also handles the cases for the input sentences 101 for which exceptions are captured and an error message is generated indicating that the sentence is an example of an exception case.

In operation 208, generating a prompt 114 by a prompt generator 110 to guide an AI engine 111 for generating one or more example sentences. Another component of the sentence mapping system 103 is evaluator 108. The evaluator 108 first loads the function specifications 105 for all the educational language standards by accessing the mapping functions library 104. Within the sentence mapping system 103, the evaluator 108 then accesses the prompt generator 110 for the purpose of generating the prompt 114. The prompt 114 is utilized for guiding the AI engine 111 into generating positive and negative test cases for each educational language standard. The prompt generator 110 is a tool or a system designed to create prompts or input statements that guide an AI model, particularly in natural language processing tasks (NLP). The generated prompts help guide the large language models (LLMs) within the AI engine 111 in producing relevant and coherent responses, facilitating more effective and tailored interactions with users or applications.

For each educational language standard, the prompt generator 110 generates a script for a positive prompt, generating one or more example sentences aligned with the specified educational language standard such as the Common Core English Language Arts (CCELA). Similarly for each educational language standard, the prompt generator 110 generates a script for a negative prompt for generating one or more example sentences that are not aligned with the specified educational language standard. Additionally, the prompt generator 110 also generates a script for the system prompt that sets up the boundary conditions for the AI engine 112 primarily for setting the context and the goals that the AI engine 112 is expected to perform throughout the session. In particular, the script for the system prompt sets the assistant's behavior as a grammar and educational expert. The scripts for the positive and negative prompts also mention the details of the specific format in which the sentences from the AI engine 112 are to be generated. The evaluator 108 gathers the information from the output generated by the prompt generator 110 to generate the prompt 114. The prompt 114 is generated by the evaluator 108 by appending the specifications for all the educational language standards from the mapping functions library 104 to the output generated by the prompt generator 110.

In operator 210, transferring the prompt to the AI engine 111 to utilize a Large Language Model (LLM) to generate the example sentences. The evaluator 108 transfers the prompt 114 to the AI engine 111 which leverages a Large Language Model (LLM) to generate the example sentences for each listed educational standards document through a built-in content generator 112. The example sentences comprise one or more than one sentence for each educational language standard which is aligned with the specific educational language standard. Similarly, the example sentences comprise one or more than one sentence for each educational language standard which is not aligned with the specific educational language standard. The generated sentences aligned with their respective educational language standards are examples of positive test cases 116 while the generated sentences not aligned with their respective language standard are examples of negative test cases 116. The evaluator 108 retrieves the generated sentences from the AI engine 111 that includes both the positive and negative test cases 116 for each educational standard.

In operation 212, evaluating one or more generated sentences, both positive and negative test cases 116, to ensure their alignment with one or more mapped language standards. The evaluator 108 interacts with the analyzer 106 for testing the language standard accuracy of the generated sentences. The generated sentences are transferred from the evaluator 108 to the analyzer 106 and are processed similarly to the input sentences 101 from the sentence database 102. The test cases 116 are generated by the AI engine 111 based on the input prompt 114. The input prompt 114 to the AI engine 112 contains information for every educational language standard. Therefore, based on the output from the AI engine 111 to the evaluator 104 in the form of test cases 116, the generated sentences are supposed to be aligned with their respective educational language standards. The analyzer 106 processes the generated sentences and then validates if the educational language standards mapped to a generated sentence after being processed are identical to the educational language standards used in the prompt 114 to generate the sentence. If the educational languages standards associated with the generated sentence exactly matches the educational language standards used in prompt 114 to generate the sentence, then the accuracy of the test cases 116 is validated. The analyzer 106 repeats the process for all the generated sentences with predefined educational language standards. The evaluator 108 records the results of the validation which determines the accuracy . . . . The generated sentences for which the predefined education standards do not match the education language standards mapped to the sentence by analyzer 106 are discarded.

In operation 214, generating a list of language standards corresponding to each input sentence 101. After the generated sentences from the AI engine 112 are validated by the analyzer 106 to be correctly mapped to their predefined educational language standards, the evaluator 108 accesses the mapping functions library 104 and adds the generated sentences, comprising positive and negative test cases 116, for each educational language standard, thereby recursively expanding the mapping functions library 104. The evaluator 108 further interacts with the analyzer 106 and generates list of input sentences 101 processed by the analyzer 106. Each sentence in the list is tagged to at least one or more than one education language standards. The evaluator 108 further transfers the list of tagged input sentences to the database of tagged sentences 120.

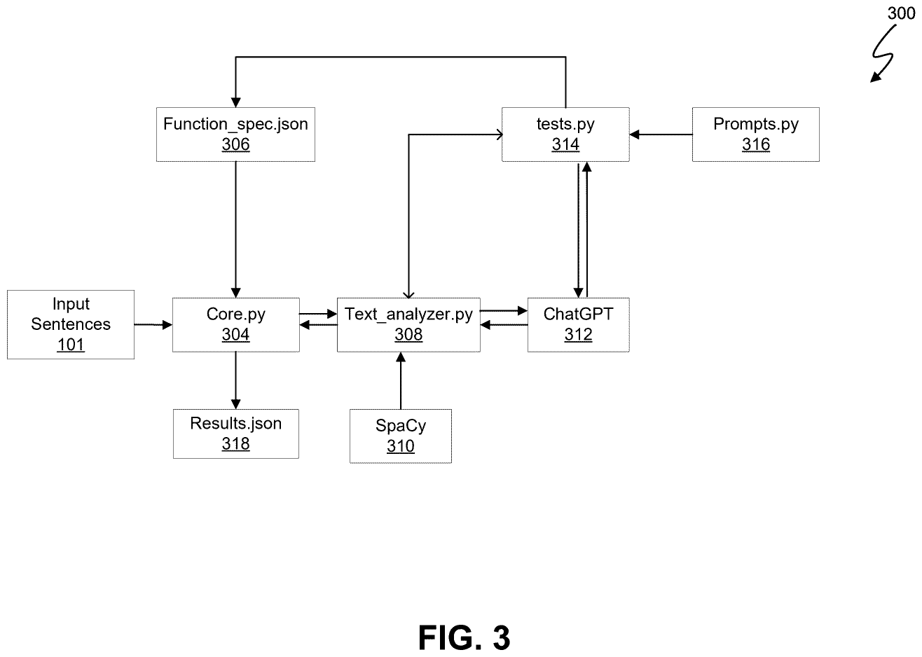

FIG. 3 depicts exemplary sentence mapping workflow 300 used by the exemplary sentence mapping system of FIG. 1. As shown here, one or more modular functions along with LLM and NLP library interact to perform sentence analysis. The exemplary modular functions are written in Python language.

The input sentence 101 that is to be analyzed is fed into the sentence mapping system 103. The input sentence 101 can be mapped to one or more standards of Common Core State Standards of English Language Arts (CCELA).

The workflow 300 begins by initializing the core.py file containing all the required environment variables. This Python code imports the os module that enables interaction with the operating system. It also imports openai module that helps connect with ChatGPT. This module reads the function specification JSON file and calls a text analyzer to analyze the sentence. The exemplary Python code of this module is mentioned below:

```
import os
import openai
from pathlib import Path
from .text_analyzer import TextAnalyzer
import json
PATH_FUNCTION_SPEC = Path(_{——}file_{——}).parent /
‘function_spec.json’
PATH_RESULTS = Path(_{——}file_{——}).parent / ‘results.json’
openai.api_key = os.getenv(‘OPENAI_API_KEY’)
with open(PATH_FUNCTION_SPEC, ‘r’) as f:
  pipeline_spec = json.load(f)
def run_pipeline(sentence, check_specific_standard):
  analysis = TextAnalyzer(sentence)
  results = analysis.process_json(pipeline_spec,
is_concurrent=False,
check_specific_standard=check_specific_standard)
  return results
if _{——}name_{——} == ‘_{——}main_{——}’:
  results = run_pipeline(‘I am a student.’)
  # save results to json file
  with open(PATH_RESULTS, ‘w’) as f:
    json.dump(results, f, indent=4)
```

Further, the function specification file function_spec.json 306 contains the definitions of all the common core state standards of English language arts. Each standard definition also includes the criteria against which a sentence is checked. A sentence qualifies for a standard by passing ‘any’ functions or ‘all’ the functions as mentioned in the criteria. An exemplary standard definition includes the following:
standard_id: Identifier for the standard (e.g., “L.3.1.c”).
description: A description of the standard (e.g., “Use abstract nouns”),
functions_to_satisfy: Specifies whether all functions must pass (“all”) or any one (“any”),
functions: A list of functions to apply, each with:
function_type: The name of the function to execute.
metadata: Additional data required by the function.
positive_cases: Example sentences generated by LLM that act as a positive test case to qualify for the standard.
negative_cases: Example sentences generated by LLM that act as a negative test case for a sentence to fail the standard.

An exemplary standard is mentioned below in which ‘functions_to_satisfy’ value is ‘any’ and “function_type”: “run_llm” indicates that this function is tested using LLM and the model name is gpt-3.5-turbo:

```
  {
    “standard_id”: “L.5.2.a”,
    “description”: “Use punctuation to separate items in a series.”,
    “functions_to_satisfy”: “any”,
    “functions”: [
      {
        “function_type”: “check_if_list”,
        “metadata”: null
      },
      {
        “function_type”: “run_llm”,
        “metadata”: {
          “model_name”: “gpt-3.5-turbo”,
          “system_prompt”: “You are a grammar expert and
educational expert. You are a fantastic curriculum and grammar expert.”,
          “user_prompt”: “Does the following sentence use
punctuation to separate items in a series? Reply either ‘Yes' or
‘No’.\n\n{sentence}”,
          “true_response”: “Yes”,
          “false_response”: “No”
        }
      }
    ],
    “positive_cases”: [
      “I packed my bag with a notebook, a pair of glasses, and a
pencil.”,
      “For dinner, I love to have pasta, fresh salad, garlic bread,
and perhaps a scoop of vanilla ice cream for dessert.”,
      “The blueprint for success includes hard work, persistence,
resilience, and a dash of good luck.”,
      “She was a famous personality, known for her expressive eyes,
charming smile, radiant beauty, and her immense talent in acting.”,
      “She was a famous, cool, nice, etc.”
    ],
    “negative_cases”: [
      “The sun set beneath the horizon, painting the sky with hues of
fiery red and soft pink.”,
      “Her favorite book inspired her to start writing her very own
non-fiction novels.”,
      “Despite the challenges he faced, the pioneer continued to
explore uncharted territories.”,
      “After graduation, she looks forward to visiting Rome, the city
filled with ancient history and rich culture.”
    ]
  }
```

The TextAnalyzer class in text_analyzer.py 308 is the core component for sentence analysis. It loads the NLP library spaCy 310 and creates an instance of the input sentence 101 to analyze. The analysis part includes reading the specification for each standard mentioned in function_spec.json 306, retrieving the list of functions that are mentioned under each criterion, and executing the functions with the provided metadata. In this example, text_analyzer.py 308 reads function_spec.json 306 through core.py 304. After the analysis steps, the final result is prepared based on the ‘pass’ or ‘fail’ output from the functions_to_satisfy condition mentioned in the function_spec.json 306.

The function specifications that are mentioned in function_spec.json 306 are used by text_analyzer.py 308 to map function_types from specification file to actual methods written in Python in text_analyzer.py 308. These methods are for various grammatical checks. Some exemplary methods are mentioned below:
check_words_exist( ): Checks if specific words are in the sentence.
includes_simple_tenses( ) Determines if only simple verb tenses are used.
is_a_simple_sentence( ): Checks if the sentence is simple, without dependent clauses.
run_llm( ) Uses OpenAI's GPT models to perform complex analyses.

An exemplary text_analyzer.py 308 code that uses NLP library spaCy 310 is mentioned below:

```
class TextAnalyzer:
  “““Analyze textual data using various checks.
  Attributes:
    nlp: A natural language processing tool.
  ”””
  def _{——}init_{——}(self, sentence):
    “““Initialize with NLP tool.”””
    self.nlp = spacy.load(“en_core_web_sm”)
    self.sentence = sentence
    self.spacy_doc = self.run_spacy_on_sentence( )
    if not self.spacy_doc:
      raise ValueError(“Unable to process sentence with spaCy.”)
  def run_spacy_on_sentence(self) −> Optional[Any]:
    try:
      doc = self.nlp(self.sentence)
    except Exception as e:
      print(f“An error occurred while processing the sentence: {e}”)
      return False
    return doc
```

This code defines a class instructor __init__ and a method run_spacy_on_sentence that utilizes the spaCy 310 library to process a given sentence using a small English language model (en_core_web_sm). This model helps in tokenization, part-of-speech (POS) tagging, named entity recognition, and dependency parsing. These functions of NLP library spaCy 310 help in performing grammatical checks for different standards.

The results from text_analyzer.py 308 are returned to core.py 304 and they are then published in results.json 318. If multiple standards are mapped to a sentence, the results are sorted by standard id in alphabetic order. Here is an exemplary code:

# Sort the results by ‘standard_id’ in alphabetical order sorted results=sorted (results, key=lambda x: x[′standard_id′])

text_analyzer.py 308 interacts with ChatGPT 312 LLM to execute the functions where the function type is “run_llm”. The user and system prompts for these functions are defined in the function_spec.json 306 file.

One of the crucial components of analysis is positive and negative test sentences that are defined under each standard in function_spec.json 306 file. These positive and negative test sentences act as test cases and are generated by tests.py 314. The process to generate these positive and negative test cases involves prompt.py 316 and ChatGPT 312 LLM.

To generate test cases prompt.py 316 provides prompts to tests.py 314 which then provides these prompts to ChatGPT 312 LLM to generate the output in the form of positive and negative sentences. The exemplary prompts for positive cases, negative cases, and system prompts are mentioned below:

POSITIVE_PROMPT = “““
You are a helpful grammar teacher that is an expert in grammar and sentence
structure. You fully comprehend what is semantically acceptable and what is
not. You are also extremely creative in helping design sentences tailored
for students' learning.
In this task, you will output a set of 4 sentences that match a common core
standard. Make sure the sentences are grammatically correct and
semantically acceptable. And output sentences of varying complexity; some
sentences should be simple, some should be medium, and some should be
complex.
The common core standard is:
Standard: {standard}
Description: {description}
Output the sentences as a list without any numbering. Just output the
sentences in this format:
- Sentence 1
- Sentence 2
- Sentence 3
- Sentence 4
”””
NEGATIVE_PROMPT = “““
You are a helpful grammar teacher that is an expert in grammar and sentence
structure. You fully comprehend what is semantically acceptable and what is
not. You are also extremely creative in helping design sentences tailored
for students' learning.
In this task, you will output a set of 4 sentences that DO NOT match a
common core standard. Make sure the sentences are grammatically correct
and semantically acceptable. And output sentences of varying complexity;
some sentences should be simple, some should be medium, and some should be
complex.
The common core standard is:
Standard: {standard}
Description: {description}
Output the sentences as a list without any numbering. Just output the
sentences in this format:
- Sentence 1
- Sentence 2
- Sentence 3
- Sentence 4
”””
SYSTEM_PROMPT = “““You are a helpful grammar and educational assistant.”””

After updating the standard details in these prompts, these are then provided to ChatGPT 312 to generate sentences. tests.py 314 writes these generated cases in the function_spec.json 306 file. The exemplary code for generating cases is shown below:

```
def generate_cases(pipeline_spec, is_positive):
  print(“IS POSITIVE: ”, is_positive)
  cases = { }
  for i in range(len(pipeline_spec)):
    print(pipeline_spec[i])
    standard = pipeline_spec[i][‘standard_id’]
    description = pipeline_spec[i][‘description’]
    try:
      prompt_template = prompt.POSITIVE_PROMPT if is_positive
else prompt.NEGATIVE_PROMPT
      user_prompt = prompt_template.format(standard=standard,
description=description)
      response = open_ai_prompt(user_prompt, “gpt-4”,
prompt.SYSTEM_PROMPT)
      sentences = handle_response_output(response)
      print(“Standard: ”, standard, “ is_positive ”, is_positive, “
description: ”, description, “Sentences: ”, sentences)
      cases[standard] = sentences
    except:
      print(“Error generating positive case for pipeline spec: ”,
pipeline_spec[i])
      continue
  return cases
def generate_all_cases( ):
  pipeline_spec =
  parse_function_spec_json(PATH_FUNCTION_SPEC)
  positive_cases = generate_cases(pipeline_spec, True)
  negative_cases = generate_cases(pipeline_spec, False)
  for i in range(len(pipeline_spec)):
    pipeline_spec[i][‘positive_cases'] =
positive_cases[pipeline_spec[i][‘standard_id’]]
    pipeline_spec[i][‘negative_cases'] =
negative_cases[pipeline_spec[i][‘standard_id’]]
  with open(PATH_FUNCTION_SPEC, ‘w’) as f:
    json.dump(pipeline_spec, f, indent=4)
```

In this code, generate_cases( ) generates the cases and generate_all_cases( ) writes the content to function_spec.json 306 file.

tests.py 314 calls TextAnalyzer class in text_analyzer.py 308 to analyze the generated content. TextAnalyzer iterates through all the test cases and evaluates them using the defined functions of each standard. After the evaluation, a mapping function maps the expected standard and the output standard predicted by TextAnalyzer. The analysis results are then recorded to calculate the accuracy. The exemplary code for this mapping to calculate accuracy is mentioned below:

```
def test_mapper_on_cases( ):
  total_count = 0
  total_wrong = 0
  pipeline_spec =
  parse_function_spec_json(PATH_FUNCTION_SPEC)
  for i in range(len(pipeline_spec)):
    standard = pipeline_spec[i][‘standard_id’]
    description = pipeline_spec[i][‘description’]
    positive_cases = pipeline_spec[i][‘positive_cases']
    negative_cases = pipeline_spec[i][‘negative_cases']
    print(“\nTesting standard: ”, standard, “ description: ”,
description)
    for case in positive_cases:
      total_count += 1
      analysis = TextAnalyzer(case)
      results = analysis.process_json(pipeline_spec,
check_specific_standard=standard, is_concurrent=True)
      for result in results:
        if result[‘standard_id’] == standard:
          if result[‘status'] != ‘passed’:
            total_wrong += 1
            print(“Standard: ”, standard, “ description: ”,
description, “ Didn't work for positive case: ”, case)
    for case in negative_cases:
      total_count += 1
      analysis = TextAnalyzer(case)
      results = analysis.process_json(pipeline_spec,
check_specific_standard=standard, is_concurrent=True)
      for result in results:
        if result[‘standard_id’] == standard:
          if result[‘status'] != ‘failed’:
            total_wrong += 1
            print(“Standard: ”, standard, “ description: ”,
description, “ Didn't work for negative case: ”, case)
print(“Total count: ”, total_count)
print(“Total wrong: ”, total_wrong)
print(“Accuracy: ”, (total_count − total_wrong) / total_count)
```

test_mapper_on_cases( ) helps to evaluate how the TextAnalyzer performs against the generated sentences.

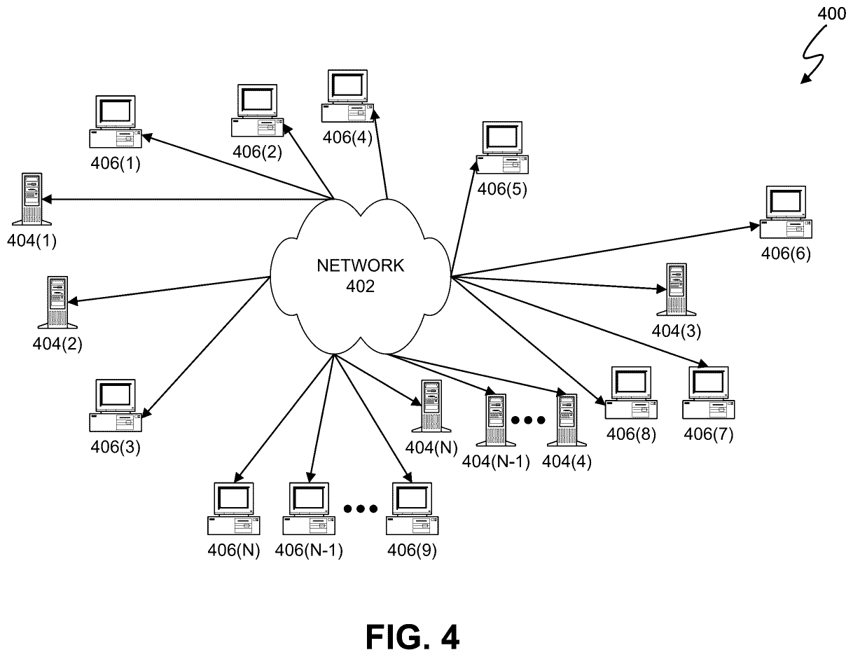

FIG. 4 is a block diagram illustrating a network environment 400 in which an automatic sentence mapping system 100 and process 200 utilizes analyzer 106 and evaluator 108 to map sentences to educational standards. Network 402 (e.g. a private wide area network (WAN) or the Internet) includes several networked server computer systems 404(1)-(N) that are accessible by client computer systems 406(1)-(N), where N is the number of server computer systems connected to the network. Communication between client computer systems 406(1)-(N) and server computer systems 404(1)-(N) typically occurs over a network, such as a public switched telephone network over asynchronous digital subscriber line (ADSL) telephone lines or high-bandwidth trunks, for example, communications channels providing T1 or OC3 service. Client computer systems 406(1)-(N) typically access server computer systems 404(1)-(N) through a service provider, such as an internet service provider (“ISP”) by executing application-specific software, commonly referred to as a browser, on one of client computer systems 406(1)-(N).

Client computer systems 406(1)-(N) and server computer systems 404(1)-(N) are specialized computers programmed to improve conventional computer systems to implement automatic sentence mapping system 100 and process 200 that utilizes analyzer 106 and evaluator 108 to map sentences to educational standards. The type of computer system that can be specially programmed to implement automatic sentence mapping system 100 and process 200 that utilizes analyzer 106 and evaluator 108 to map sentences to educational standards includes a mainframe, a mini-computer, a personal computer system including notebook computers, a wireless, mobile computing device (including personal digital assistants, smartphones, and tablet computers). These computer systems are typically designed to provide computing power to one or more users locally or remotely. Each computer system may also include one or a plurality of input/output (“I/O”) devices coupled to the system processor to perform specialized functions. Tangible, non-transitory memories (also referred to as “storage devices”) such as hard disks, compact disk (“CD”) drives, digital versatile disk (“DVD”) drives, and magneto-optical drives may also be provided, either as an integrated or peripheral device. In at least one embodiment, the automatic sentence mapping system 100 and process 200 that utilizes analyzer 106 and evaluator 108 to map sentences to educational standards can be implemented using code stored in a tangible, non-transient computer-readable medium and executed by one or more processors. In at least one embodiment, the automatic sentence mapping system 100 and process 200 that utilizes analyzer 106 and evaluator 108 to map sentences to educational standards can be implemented completely in hardware using, for example, logic circuits and other circuits including field programmable gate arrays.

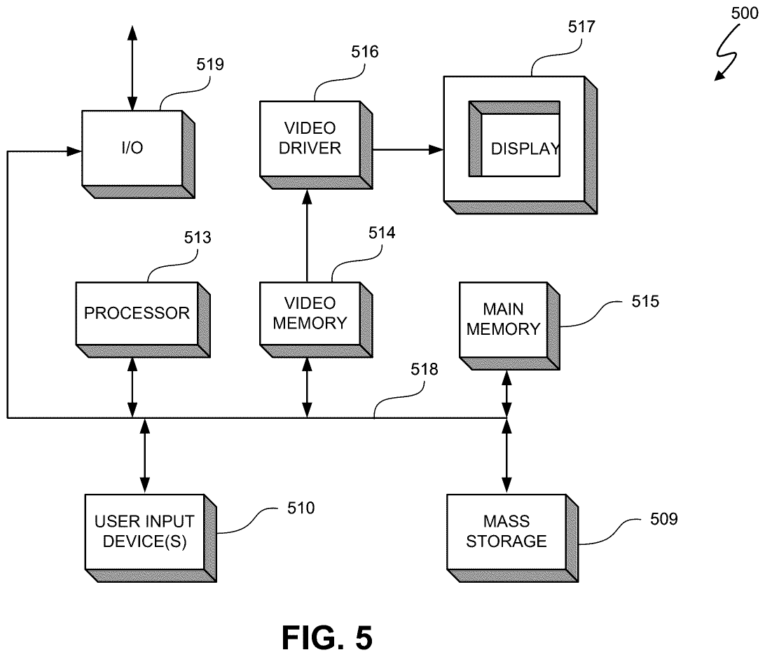

Embodiments of the automatic sentence mapping system 100 and process 200 that utilizes analyzer 106 and evaluator 108 to map sentences to educational standards can be implemented on a computer system such as a special-purpose, special-programmed computer 500 illustrated in FIG. 5. Input user device(s) 510, such as a keyboard and/or mouse, are coupled to a bi-directional system bus 518. The input user device(s) 510 are for introducing user input to the computer system and communicating that user input to processor 513. The computer system of FIG. 5 generally also includes a non-transitory video memory 514, non-transitory main memory 515, and non-transitory mass storage 509, all coupled to bi-directional system bus 518 along with input user device(s) 510 and processor 513. The mass storage 509 may include fixed and removable media, such as a hard drive, one or more CDs or DVDs, solid state memory including flash memory, and other available mass storage technology. Bus 518 may contain, for example, 32 of 64 address lines for addressing video memory 514 or main memory 515. The system bus 518 also includes, for example, an n-bit data bus for transferring DATA between and among the components, such as CPU 509, main memory 515, video memory 514, and mass storage 509, where “n” is, for example, 32 or 64. Alternatively, multiplex data/address lines may be used instead of separate data and address lines.

I/O device(s) 519 may provide connections to peripheral devices, such as a printer, and may also provide a direct connection to a remote server computer system via a telephone link or to the Internet via an ISP. I/O device(s) 519 may also include a network interface device to provide a direct connection to a remote server computer system via a direct network link to the Internet via a POP (point of presence). Such connection may be made using, for example, wireless techniques, including digital cellular telephone connection, Cellular Digital Packet Data (CDPD) connection, digital satellite data connection, or the like. Examples of I/O devices include modems, sound and video devices, and specialized communication devices such as the aforementioned network interface.

Computer programs and data are generally stored as code in a non-transient computer-readable medium such as flash memory, optical memory, magnetic memory, compact disks, digital versatile disks, and any other type of memory. The computer program is loaded from a memory, such as mass storage 509, into main memory 515 for execution. Computer programs may also be in the form of electronic signals modulated in accordance with the computer program and data communication technology when transferred via a network. In at least one embodiment, Java applets or any other technology is used with web pages to allow a user of a web browser to make and submit selections and allow a client computer system to capture the user selection and submit the selection data to a server computer system.

The processor 513, in one embodiment, is a microprocessor manufactured by Motorola Inc. of Illinois, Intel Corporation of California, or Advanced Micro Devices of California. However, any other suitable single or multiple microprocessors or microcomputers may be utilized. Main memory 515 consists of dynamic random access memory (DRAM). Video memory 514 is a dual-ported video random access memory. One port of the video memory 514 is coupled to the video driver 516. The video driver 516 is used to drive the display 517. Video driver 516 is well-known in the art and may be implemented by any suitable means. This circuitry converts pixel DATA stored in video memory 514 to a raster signal suitable for use by display 517. Display 517 is a type of monitor suitable for displaying graphic images.

The computer system described above is for purposes of example only. The automatic sentence mapping system 100 and process 200 utilizes analyzer 106 and evaluator 108 to map sentences to educational standards and may be implemented in any type of computer system programming or processing environment. It is contemplated that the automatic sentence mapping system 100 and process 200 utilize analyzer 106 and evaluator 108 to map sentences to educational standards that might run on a stand-alone computer system, such as the one described above. The automatic sentence mapping system 100 and process 200 utilizes analyzer 106 and evaluator 108 to map sentences to educational standards might also run from a server computer system that can be accessed by a plurality of client computer systems interconnected over an intranet network. Finally, the automatic sentence mapping system 100 and process 200 that utilizes analyzer 106 and evaluator 108 to map sentences to educational standards may be run from a server computer system that is accessible to clients over the Internet.

Although embodiments have been described in detail, it should be understood that various changes, substitutions, and alterations can be made herein without departing from the spirit and scope of the invention as defined by the appended claims.

What is claimed is:

1. A method for mapping one or more input sentences to educational language standards comprising:
executing codes using one or more processors of a computer system to cause the computer system to perform operations comprising:
receiving one or more input sentences from a sentence database, wherein the sentences database stores a list of sentences each aligning with one or more educational language standards;
accessing a mapping functions library including a list of functions, wherein the functions are executed to check the mapping of input sentences to one or more language standards;
analyzing one or more sentences to map each sentence against one or more relevant language standards, wherein the analysis includes executing the list of functions such that each sentence runs through one or more functions to identify mapped language standards;
generating a prompt by a prompt generator to guide an AI engine for generating one or more example sentences including at least one positive sentence and at least one negative sentence for each language standard;
transferring the prompt to the AI engine to utilize a large language model (LLM) to generate the example sentences, wherein the generated example sentences are used to validate if the analyzed sentence maps against the corresponding language standards;
evaluating one or more example sentences to ensure their alignment with the one or more language standards; and
generating a list of language standards corresponding to each sentence, wherein the list of language standards includes the language standards that are mapped against the corresponding sentence.

2. The method of claim 1 wherein the list of functions is stored in a JSON file format in the standards library, such that the file includes definitions of language standards and associated checking functions.

3. The method of claim 1 wherein each function includes a unique identifier showing its relation to a language standard such that the functions are executed to check if a received input sentence maps against the respective language standards.

4. The method of claim 1 wherein the language standards include Common Core English Language Arts (CCELA) standards.

5. The method of claim 1 wherein the prompt generator further generates a second prompt including a system prompt setting boundary conditions for the AI engine and a user prompt asking a query related to mapping of the input sentence to the corresponding language standard.

6. The method of claim 1 further comprises:
calling an NLP library;
executing one or more functions to identify matching language standards for the input sentences; and
providing a list of matching standards as an output.

7. The method of claim 1 further comprising:
evaluating one or more input sentences to be grammatically correct, wherein evaluating the input sentences includes running one or more programmatic checks or natural language processing techniques to identify the 4 grammatically correct input sentences.

8. The method of claim 7 discards the grammatically incorrect sentences post evaluating.

9. The method of claim 1 stores the list of functions in a JSON format, wherein the JSON format is a machine-readable format that allows for efficient searching and retrieval.

10. The method of claim 1 wherein the AI engine uses OpenAI's GPT models to generate the example sentences, and input sentences are matched against the example sentences to validate the mapping of input sentences with corresponding language standards.

11. A system for mapping one or more input sentences to educational language standards comprising:
one or more processors of a computer system;
memory, coupled to the one or more processors, that stores code and execution of the code by the one or more processors causes the computer system to perform operations comprising:
receiving the one or more input sentences from a sentences database, wherein the sentences database stores a list of sentences each aligning with one or more educational language standards;
accessing a standards library including a list of functions, wherein the functions are executed to check mapping of inputs sentences to one or more language standard;
analyzing the one or more sentences to map each sentence against one or more relevant language standards, wherein the analysis include executing the list of functions such that each sentence runs through one or more functions to identify mapped language standards;
generating a prompt by a prompt generator to guide an AI engine for generating one or more example sentences including at least one positive sentence and at least one negative sentence for each language standard;
transferring the prompt to the AI engine to utilize a large language model (LLM) to generate the example sentences, wherein the generated example sentences are used to validate if the analyzed sentence maps against the corresponding language standards;
evaluating one or more example sentences to ensure their alignment with the one or more language standards; and
generating a list of language standards corresponding to each sentence, wherein the list of language standards includes the language standards that are mapped against the corresponding sentence.

12. The system of claim 11 wherein the list of functions are stored in a JSON file format in the standards library, such that the file includes definitions of language standards and associated checking functions.

13. The system of claim 11 wherein each function includes a unique identifier showing its relation to a language standard such that the functions are executed to check if a received input sentence maps against the respective language standards.

14. The system of claim 11 wherein the language standards include Common Core English Language Arts (CCELA) standards.

15. The system of claim 11 wherein the prompt generator further generates a second prompt including a system prompt setting boundary condition for the AI engine and a user prompt asking a query related to mapping of the input sentence to corresponding language standard.

16. The system of claim 11 further includes an NLP library spaCy, wherein the NLP library is called to execute one or more functions for identifying matching language standards for the input sentences.

17. The system of claim 11 further comprising:
evaluating the one or more input sentences to be grammatically correct, wherein evaluating the input sentences includes running one or more programmatic checks or natural language processing techniques to identify the grammatically correct input sentences.

18. The system of claim 17 discards the grammatically incorrect sentences post evaluating.

19. The system of claim 11 stores the list of functions in a JSON format, wherein the JSON format is a machine-readable format that allows for efficient searching and retrieval.

20. The system of claim 11 wherein the AI engine uses OpenAI's GPT models to generate the example sentences, and input sentences are matched against the example sentences to validate the mapping of input sentences with corresponding language standards.
